(19) United States
(12) Patent Application Publication
(10) Pub. No.: US 2022/0350987 A1
(43) Pub. Date: Nov. 3, 2022

(54) FEATURE AMOUNT EXTRACTION DEVICE, TIME-SEQUENTIAL INFERENCE APPARATUS, TIME-SEQUENTIAL LEARNING SYSTEM, TIME-SEQUENTIAL FEATURE AMOUNT EXTRACTION METHOD, TIME-SEQUENTIAL INFERENCE METHOD, AND TIME-SEQUENTIAL LEARNING METHOD

(71) Applicant: Mitsubishi Electric Corporation, Tokyo (JP)

(72) Inventors: Jun MARUTA, Tokyo (JP); Genta YOSHIMURA, Tokyo (JP)

(73) Assignee: Mitsubishi Electric Corporation, Tokyo (JP)

(21) Appl. No.: 17/866,334

(22) Filed: Jul. 15, 2022

Related U.S. Application Data
(63) Continuation of application No. PCT/JP2020/015519, filed on Apr. 6, 2020.

(51) Int. Cl. G06K 9/00; G06K 9/62

(52) U.S. Cl. CPC G06K 9/00523; G06K 9/6256

(57) ABSTRACT

The feature amount extraction device includes: a data acquisition unit to acquire time-sequential data as input time-sequential data; a multiple-filter application unit, including multiple digital filters, to apply each of the digital filters to the input time-sequential data acquired by the data acquisition unit, and output, for each of the digital filters, filter response time-sequential data that is time-sequential data including a time-sequential feature or a frequency feature after having undergone the application; and a feature amount extracting unit to extract feature amounts for a plurality of pieces of the filter response time-sequential data output from the multiple-filter application unit for each of the plurality of pieces of the filter response time-sequential data, and output the extracted feature amounts as feature amount data.

### CROSS REFERENCE TO RELATED APPLICATION

This application is a Continuation of PCT International Application No. PCT/JP2020/015519, filed on Apr. 6, 2020, which is hereby expressly incorporated by reference into the present application.

### TECHNICAL FIELD

The present disclosure relates to a feature amount extraction device, a time-sequential inference apparatus, a time-sequential learning system, a time-sequential feature amount extraction method, a time-sequential inference method, and a time-sequential learning method.

### BACKGROUND ART

A time-sequential inference apparatus is known that performs inference on an operation of a machine on the basis of time-sequential data using a machine learning model that enables inference on the operation of the machine.

For example, a technology disclosed in Patent Literature 1 (hereinafter referred to as “related art”) randomly selects a predetermined number of sets (hereinafter referred to as “filter sets”) of a recursive filter and a stable filter that are randomly selected, and generates a machine learning model using, as training data, time-sequential data that has passed through each of a plurality of selected filter sets. The time-sequential inference apparatus can obtain an inference result output by the machine learning model by inputting the time-sequential data that has passed through each of the plurality of filter sets described above to the machine learning model described above.

### CITATION LIST

### Patent Literature

Patent Literature 1: JP 2018-116693 A

### SUMMARY OF INVENTION

### Technical Problem

In the related art, a noise component included in time-sequential values of the time-sequential data output from a sensor that monitors the operation of the machine is reduced by the filter set to improve the inference accuracy.

However, since the filter set in the related art is randomly selected and the recursive filter and the stable filter constituting the filter set are also randomly selected, the related art may not be able to sufficiently suppress the noise component included in the time-sequential values of the time-sequential data. As a result, the related art has a problem that inference accuracy may decrease.

The present disclosure is intended to solve the above-described problems, and an object thereof is to provide a feature amount extraction device capable of suppressing a noise component included in time-sequential values of time-sequential data.

### Solution to Problem

The feature amount extraction device according to the present disclosure includes: a data acquirer to acquire time-sequential data as input time-sequential data; a multiple-filter applicator, including multiple digital filters randomly selected, to apply each of the digital filters to the input time-sequential data acquired by the data acquirer and output, for each of a plurality of the digital filters, filter response time-sequential data that is time-sequential data including a time-sequential feature or a frequency feature after having undergone the application; and a feature amount extractor to extract feature amounts for a plurality of pieces of the filter response time-sequential data output from the multiple-filter applicator for each of the plurality of pieces of the filter response time-sequential data, and output a plurality of the feature amounts that have been extracted as feature amount data.

### Advantageous Effects of Invention

According to the present disclosure, it is possible to suppress a noise component included in time-sequential values of time-sequential data.

### BRIEF DESCRIPTION OF DRAWINGS

FIG. 1 is a block diagram illustrating an example of configurations of main parts of a feature amount extraction device and a time-sequential inference apparatus according to a first embodiment.

FIG. 2 is an explanatory diagram illustrating an example of a multiple-filter application unit according to the first embodiment.

FIG. 3 is an explanatory diagram illustrating an example of a case where the multiple-filter application unit according to the first embodiment includes RPFB.

FIG. 4 is an explanatory diagram illustrating an example of a feature amount extracting unit according to the first embodiment.

FIG. 5 is an explanatory diagram illustrating an example of feature amount data output from the feature amount extracting unit according to the first embodiment.

FIGS. 6A and 6B are diagrams illustrating an example of a hardware configuration of a main part of the feature amount extraction device according to the first embodiment.

FIG. 7 is a flowchart illustrating an example of processing performed by the feature amount extraction device according to the first embodiment.

FIGS. 8A and 8B are diagrams illustrating an example of a hardware configuration of a main part of the time-sequential inference apparatus according to the first embodiment.

FIG. 9 is a flowchart illustrating an example of processing performed by the time-sequential inference apparatus according to the first embodiment.

FIG. 10 is a block diagram illustrating an example of a configuration of a main part of a time-sequential learning system according to the first embodiment.

FIGS. 11A and 11B are diagrams illustrating an example of a hardware configuration of a main part of a time-sequential learning device according to the first embodiment.

FIG. 12 is a flowchart illustrating an example of processing performed by the time-sequential learning device according to the first embodiment.

FIG. 13 is a flowchart illustrating an example of processing in a case where the time-sequential learning device according to the first embodiment trains a learning model by unsupervised learning.

FIG. 14 is a block diagram illustrating an example of configurations of main parts of a feature amount extraction device and a time-sequential inference apparatus according to a second embodiment.

FIG. 15 is an explanatory diagram illustrating an example of a multiple-filter application unit according to the second embodiment.

FIG. 16 is a flowchart illustrating an example of processing performed by the feature amount extraction device according to the second embodiment.

FIG. 17 is a flowchart illustrating an example of processing performed by the time-sequential inference apparatus according to the second embodiment.

FIG. 18 is a block diagram illustrating an example of a configuration of a main part of a time-sequential learning system according to the second embodiment.

### DESCRIPTION OF EMBODIMENTS

Embodiments of the present disclosure will now be described in detail with reference to the drawings.

### First Embodiment

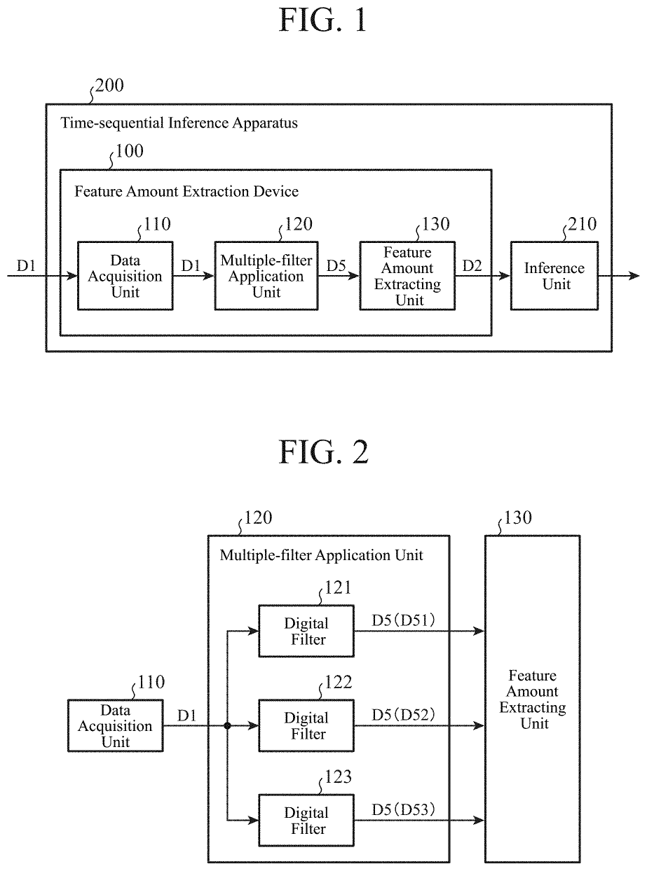

A feature amount extraction device 100 according to a first embodiment and a time-sequential inference apparatus 200 to which the feature amount extraction device 100 is applied will be described with reference to FIGS. 1 to 9.

FIG. 1 is a block diagram illustrating an example of configurations of main parts of the feature amount extraction device 100 and the time-sequential inference apparatus 200 according to the first embodiment.

The time-sequential inference apparatus 200 according to the first embodiment includes the feature amount extraction device 100 and an inference unit 210. The time-sequential inference apparatus 200 will be described later.

The feature amount extraction device 100 according to the first embodiment includes a data acquisition unit 110, a multiple-filter application unit 120, and a feature amount extracting unit 130.

The data acquisition unit 110 acquires time-sequential data as input time-sequential data D1.

The input time-sequential data D1 is time-sequential information indicating a physical quantity counted, measured, observed, or aggregated at predetermined time intervals.

Specifically, the input time-sequential data D1 is obtained by converting a signal output from a sensor such as a vibration sensor, a distance measuring sensor, a rotation sensor, a gyro sensor, a temperature sensor, or a sound sensor into time-sequential information. The input time-sequential data D1 is not limited to information obtained by converting a signal output from the sensor into time-sequential information as long as the input time-sequential data D1 is time-sequential information indicating a physical quantity counted, measured, observed, or aggregated at predetermined time intervals. Note that the predetermined time intervals do not need to be uniform, and the time intervals include a freely set interval.

For example, the data acquisition unit 110 acquires the input time-sequential data D1 by reading the input time-sequential data D1 from a storage device (not illustrated).

Since the data acquisition unit 110 only needs to be able to acquire the input time-sequential data D1, a source from which the input time-sequential data D1 is acquired by the data acquisition unit 110 or a method with which the data acquisition unit 110 acquires the input time-sequential data D1 is not limited.

The multiple-filter application unit 120 includes a plurality of digital filters, applies each of the digital filters to the input time-sequential data D1 acquired by the data acquisition unit 110, and outputs time-sequential data that has undergone the application (this time-sequential data is hereinafter referred to as “filter response time-sequential data D5”) for each of the digital filters.

The filter response time-sequential data D5 output from each of the plurality of digital filters included in the multiple-filter application unit 120 is time-sequential data including a time-sequential feature or a frequency feature.

Here, the time-sequential data including a time-sequential feature is time-sequential data obtained by applying a digital filter that recursively uses a time-sequential value such as an IIR filter to the time-sequential data.

In addition, the time-sequential data including a frequency feature is time-sequential data obtained by applying a digital filter that acts as a frequency-based filter such as a low-pass filter, a high-pass filter, or a band-pass filter to time-sequential data.

The multiple-filter application unit 120 according to the first embodiment will be described with reference to FIG. 2.

FIG. 2 is an explanatory diagram illustrating an example of the multiple-filter application unit 120 according to the first embodiment.

The multiple-filter application unit 120 includes a plurality of digital filters 121, 122, and 123.

FIG. 2 illustrates, as an example, the multiple-filter application unit 120 including three digital filters 121, 122, and 123. The number of digital filters included in the multiple-filter application unit 120 is not limited to three, and may be two or four or more as long as it is two or more.

The multiple-filter application unit 120 applies each of the digital filters 121, 122, and 123 to the input time-sequential data D1 acquired by the data acquisition unit 110. Each of the plurality of digital filters 121, 122, and 123 included in the multiple-filter application unit 120 performs filtering processing on the input time-sequential data D1, and the digital filters 121, 122, and 123 output filter response time-sequential data D51, D52, and D53 which are time-sequential data having undergone the filtering processing.

The filter response time-sequential data D51, D52, and D53 respectively output from the plurality of digital filters 121, 122, and 123 included in the multiple-filter application unit 120 are time-sequential data including time-sequential features or frequency features.

Each of the plurality of digital filters 121, 122, and 123 included in the multiple-filter application unit 120 includes a low-pass filter, a high-pass filter, a band-pass filter, a band elimination filter, a finite impulse response (FIR) filter, a moving average filter, an infinite impulse response (IIR) filter, a constant K filter, an M-derived filter, an optimum “L” filter, a Gaussian filter, an hourglass filter, a raised cosine filter, a Bessel filter, a comb filter, a Butterworth filter, a Chebyshev filter, an elliptical filter, or the like.

The plurality of digital filters 121, 122, and 123 included in the multiple-filter application unit 120 is arranged in parallel or in series. Note that FIG. 2 illustrates an example in which the plurality of digital filters 121, 122, and 123 included in the multiple-filter application unit 120 is arranged in parallel.

In addition, the multiple-filter application unit 120 may include a random projection filter bank (RPFB) described in Patent Literature 1 as a plurality of digital filters. The RPFB described in Patent Literature 1 (hereinafter simply referred to as “RPFB”) is obtained by randomly selecting a predetermined number of sets (hereinafter referred to as “filter sets”) of randomly selected recursive filters and stable filters.

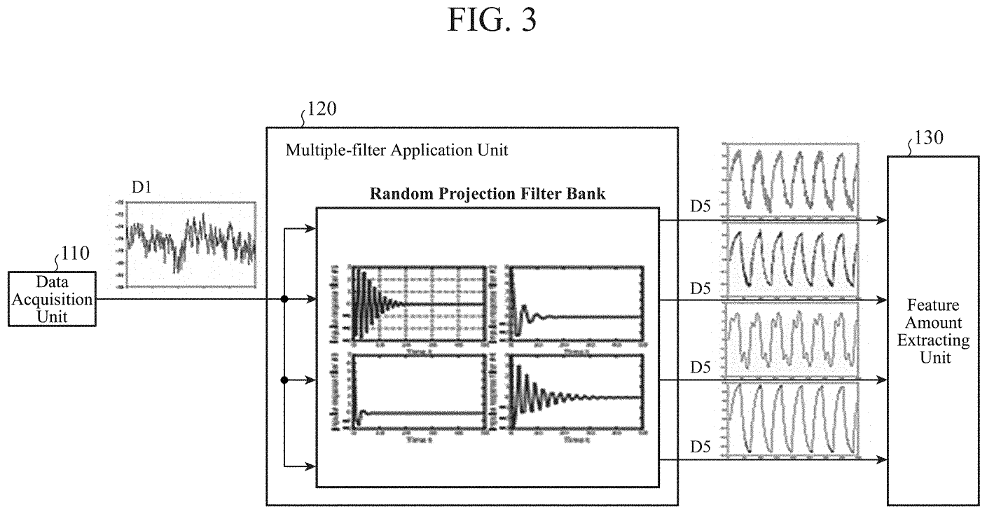

The case where the multiple-filter application unit 120 according to the first embodiment includes RPFB as a plurality of digital filters will be described with reference to FIG. 3.

FIG. 3 is an explanatory diagram illustrating an example of the multiple-filter application unit 120 according to the first embodiment including RPFB as a plurality of digital filters.

As illustrated in FIG. 3, in a case where the multiple-filter application unit 120 includes RPFB as the plurality of digital filters, the multiple-filter application unit 120 applies each of the plurality of filter sets to the input time-sequential data D1. The multiple-filter application unit 120 outputs filter response time-sequential data D5, which is time-sequential data obtained by applying the recursive filter and the stable filter constituting the filter set to the input time-sequential data D1, for each filter set. Note that FIG. 3 illustrates a case where RPFB selects four filter sets as an example.

In a case where the multiple-filter application unit 120 includes RPFB as a plurality of digital filters, the multiple-filter application unit 120 may include a digital filter (not illustrated in FIG. 3) such as a Gaussian filter in addition to the RPFB, and the Gaussian filter may be arranged in parallel with the RPFB.

The feature amount extracting unit 130 extracts feature amounts for a plurality of pieces of the filter response time-sequential data D5 output by the multiple-filter application unit 120 for each of the plurality of pieces of the filter response time-sequential data D5, and outputs the extracted feature amounts as feature amount data D2.

With this configuration, the feature amount extraction device 100 can suppress a noise component included in time-sequential values of the time-sequential data.

Specifically, the feature amount extraction device 100 includes the feature amount extracting unit 130, thereby being capable of outputting the feature amount data D2 in which the noise component included in the time-sequential values of the time-sequential data is suppressed even when the multiple-filter application unit 120 includes, for example, RPFB.

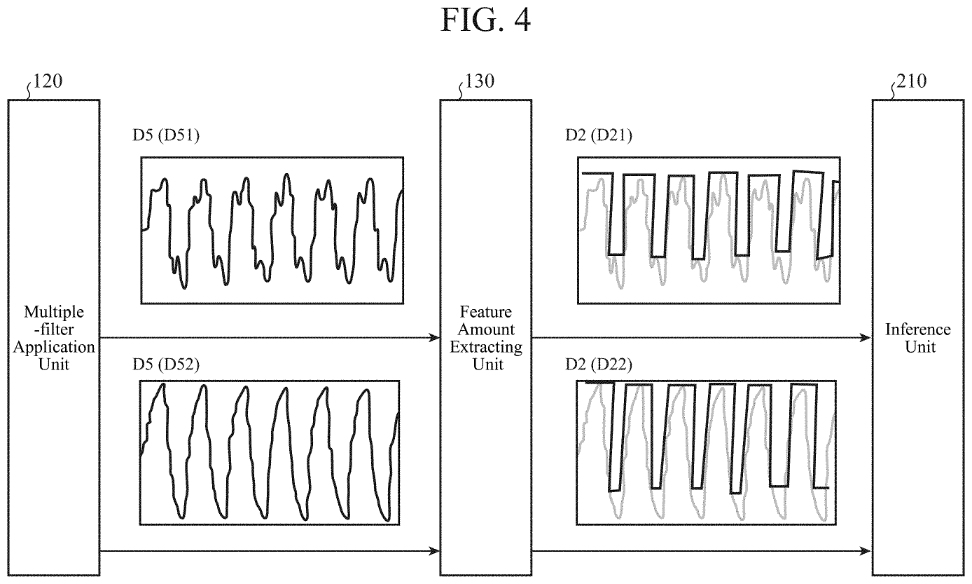

The feature amount extracting unit 130 according to the first embodiment will be described with reference to FIG. 4.

FIG. 4 is an explanatory diagram illustrating an example of the feature amount extracting unit 130 according to the first embodiment.

FIG. 4 illustrates, as an example, a case where the multiple-filter application unit 120 outputs two pieces of filter response time-sequential data D51 and D52.

The feature amount extracting unit 130 illustrated in FIG. 4 applies a sliding window to each of the two pieces of filter response time-sequential data D51 and D52 output from the multiple-filter application unit 120. The feature amount extracting unit 130 applies a sliding window to each of the two pieces of filter response time-sequential data D51 and D52 to extract statistics corresponding to each of the two pieces of filter response time-sequential data D51 and D52 as feature amounts.

More specifically, for example, the feature amount extracting unit 130 applies a sliding window to each of the two pieces of filter response time-sequential data D51 and D52, and performs envelope processing on each of the two pieces of filter response time-sequential data D51 and D52, thereby extracting the feature amounts corresponding to each of the filter response time-sequential data D51 and D52.

The feature amount extracting unit 130 outputs feature amount data D21 and D22 indicating the feature amounts respectively corresponding to the extracted filter response time-sequential data D51 and D52.

A method for performing envelope processing by applying a sliding window is well known, and thus, the description thereof will be omitted.

For example, the feature amount extracting unit 130 performs envelope processing for extracting a maximum value of the time-sequential values of the filter response time-sequential data D5 in a window, thereby extracting a feature amount corresponding to the filter response time-sequential data D5.

The envelope processing performed by the feature amount extracting unit 130 by applying the sliding window to the filter response time-sequential data D5 is not limited to the processing of extracting the maximum value of the time-sequential values of the filter response time-sequential data D5 in the window. For example, the feature amount extracting unit 130 may extract a minimum value, a mean value, or a median value of the time-sequential values of the filter response time-sequential data D5 in the window.

FIG. 4 illustrates, as an example, a case where the feature amount extracting unit 130 performs envelope processing of extracting a maximum value of time-sequential values of the filter response time-sequential data D5 in a window to extract a feature amount corresponding to the filter response time-sequential data D5.

In FIG. 4, the feature amount data D21 and D22 are indicated by rectangular wave-shaped solid lines.

The feature amount extracting unit 130 may combine first envelope processing of extracting a maximum value, a minimum value, a mean value, or a median value of time-sequential values of the filter response time-sequential data D5 in a window and second envelope processing of extracting a value other than the value extracted by the first envelope processing among the maximum value, the minimum value, the mean value, and the median value of the time-sequential values, and output two pieces of feature amount data D2 for one piece of filter response time-sequential data D5.

Note that the envelope processing in the feature amount extracting unit 130 is not limited to combine the two types of envelope processing that are the first envelope processing and the second envelope processing, and the feature amount extracting unit 130 may combine three or more types of envelope processing to output three or more pieces of feature amount data D2 for one piece of filter response time-sequential data D5.

In addition, the feature amount extracting unit 130 may perform envelope processing for extracting a quartile value of the time-sequential values of the filter response time-sequential data D5 in a window, thereby extracting a feature amount corresponding to the filter response time-sequential data D5.

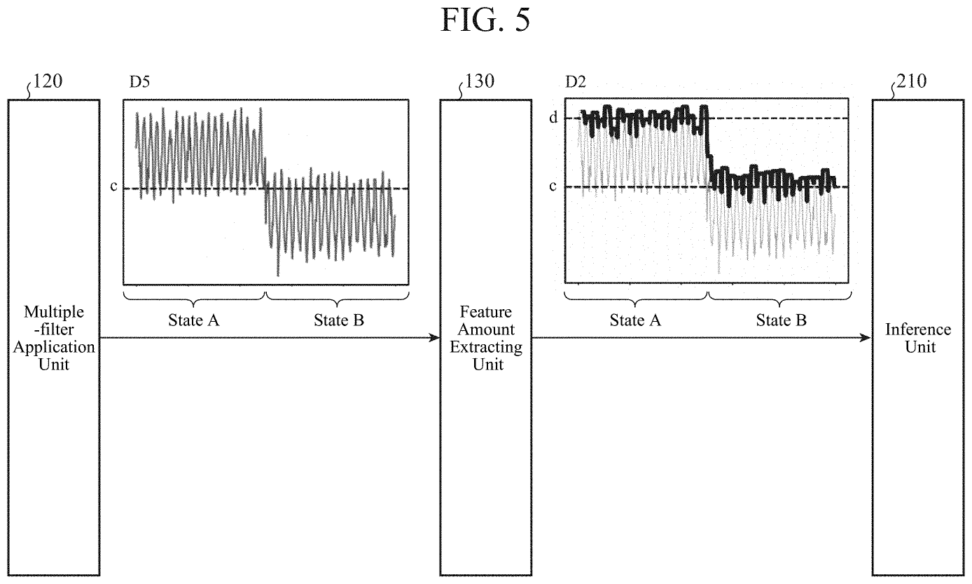

The feature amount data D2 output from the feature amount extracting unit 130 according to the first embodiment will be described with reference to FIG. 5.

FIG. 5 is an explanatory diagram illustrating an example of the feature amount data D2 output from the feature amount extracting unit 130 according to the first embodiment.

FIG. 5 illustrates, as an example, a case where the feature amount extracting unit 130 performs envelope processing of extracting a maximum value of time-sequential values of the filter response time-sequential data D5 in a window to extract a feature amount corresponding to the filter response time-sequential data D5.

In FIG. 5, the feature amount data D2 is indicated by a thick solid line.

The filter response time-sequential data D5 illustrated in FIG. 5 is time-sequential data that oscillates at a value higher than a predetermined threshold c as a whole in state A, and oscillates at a value lower than the threshold c as a whole in state B.

However, the filter response time-sequential data D5 illustrated in FIG. 5 has a time point at which the time-sequential values in state A are lower than the threshold c and a time point at which the time-sequential values in state B are higher than the threshold c. In a case where an inference target is inferred on the basis of such filter response time-sequential data D5 using the threshold c as a reference, the accuracy of the inference may be reduced.

On the other hand, the feature amount data D2 illustrated in FIG. 5 is time-sequential data that oscillates in the vicinity of a predetermined threshold d in state A and oscillates in the vicinity of the threshold c in state B. The inference accuracy can be improved by inferring the inference target on the basis of such feature amount data D2 using an intermediate value between the threshold c and the threshold d as a reference.

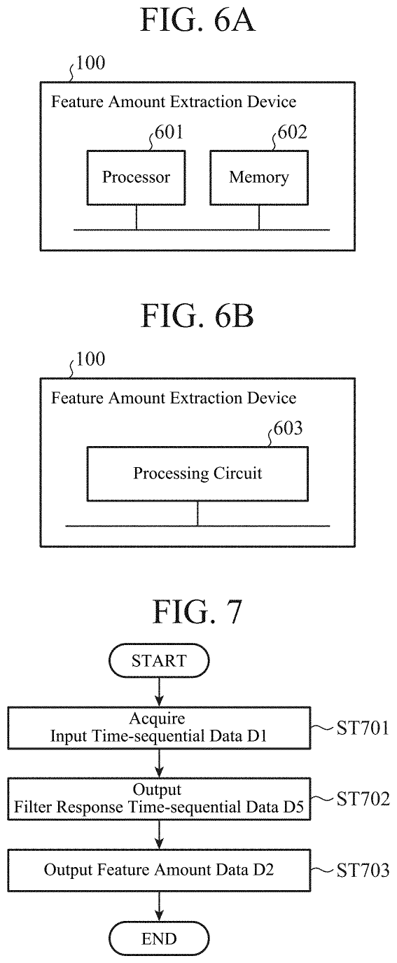

A hardware configuration of a main part of the feature amount extraction device 100 according to the first embodiment will be described with reference to FIGS. 6A and 6B.

FIGS. 6A and 6B are diagrams illustrating an example of the hardware configuration of main parts of the feature amount extraction device 100 according to the first embodiment.

As illustrated in FIG. 6A, the feature amount extraction device 100 is implemented by a computer, and the computer includes a processor 601 and a memory 602.

The memory 602 stores a program for causing the computer to function as the data acquisition unit 110, the multiple-filter application unit 120, and the feature amount extracting unit 130. The processor 601 reads and executes the program stored in the memory 602, thereby implementing the data acquisition unit 110, the multiple-filter application unit 120, and the feature amount extracting unit 130.

In addition, as illustrated in FIG. 6B, the feature amount extraction device 100 may include a processing circuit 603. In this case, the functions of the data acquisition unit 110, the multiple-filter application unit 120, and the feature amount extracting unit 130 may be implemented by the processing circuit 603.

Furthermore, the feature amount extraction device 100 may include the processor 601, the memory 602, and the processing circuit 603 (this configuration is not illustrated). In this case, some of the functions of the data acquisition unit 110, the multiple-filter application unit 120, and the feature amount extracting unit 130 may be implemented by the processor 601 and the memory 602, and the remaining functions may be implemented by the processing circuit 603.

The processor 601 uses, for example, a central processing unit (CPU), a graphics processing unit (GPU), a microprocessor, a microcontroller, or a digital signal processor (DSP).

The memory 602 uses, for example, a semiconductor memory or a magnetic disk. More specifically, the memory 602 uses, for example, a random access memory (RAM), a read only memory (ROM), a flash memory, an erasable programmable read only memory (EPROM), an electrically erasable programmable read only memory (EEPROM), a solid state drive (SSD), or a hard disk drive (HDD).

The processing circuit 603 uses, for example, an application specific integrated circuit (ASIC), a programmable logic device (PLD), a field-programmable gate array (FPGA), a system-on-a-chip (SoC), or a system large-scale integration (LSI).

The operation of the feature amount extraction device 100 according to the first embodiment will be described with reference to FIG. 7.

FIG. 7 is a flowchart illustrating an example of processing performed by the feature amount extraction device 100 according to the first embodiment.

First, in step ST701, the data acquisition unit 110 acquires the input time-sequential data D1.

Next, in step ST702, the multiple-filter application unit 120 applies a plurality of digital filters to the input time-sequential data D1, and outputs filter response time-sequential data D5 for each of the digital filters.

Next, in step ST703, the feature amount extracting unit 130 extracts a feature amount for each piece of filter response time-sequential data D5 and outputs feature amount data D2.

After step ST703, the feature amount extraction device 100 ends the processing of the flowchart. After completing the processing of the flowchart, the feature amount extraction device 100 returns to step ST701 and repeatedly executes the processing of the flowchart.

As described above, the time-sequential inference apparatus 200 according to the first embodiment includes the feature amount extraction device 100 and the inference unit 210.

The inference unit 210 performs inference on a predetermined inference target using the feature amount data D2 output from the feature amount extraction device 100 as input data, and outputs inference result information indicating an inference result.

Specifically, the inference unit 210 performs inference on a predetermined inference target using a plurality of pieces of feature amount data D2 output from the feature amount extracting unit 130 included in the feature amount extraction device 100 as input data.

In a case where the input time-sequential data D1 is based on a sound signal, the inference target includes sound identification, sound detection, sound classification, prediction of a sound frequency, or the like. The sound identification includes, for example, identification of a speaker, identification of animal barking, identification of abnormal sound, and the like.

In addition, in a case where the input time-sequential data D1 is based on a radar signal, the inference target includes, for example, identification of a target, detection of an abnormality, detection of an unknown target, classification of an object, prediction of a position of a target, prediction of a speed of a target, prediction of a distance to a target, or the like.

In addition, in a case where the input time-sequential data D1 is based on a vibration signal, the inference target includes identification of abnormal vibration, detection of abnormal vibration, classification of vibration, prediction of remaining life, or the like of a machine or a machine component such as a bearing, a motor, a screw, or a spring.

The inference target is not limited to those described above.

Specifically, the inference unit 210, for example, inputs the feature amount data D2 to a trained model corresponding to the learning result by machine learning, acquires the inference result information output as the inference result by the trained model, and outputs the acquired inference result information. The inference unit 210 may have a trained model in advance, and may acquire the trained model by reading the trained model from a storage device (not illustrated) that stores the trained model in advance.

A method for generating the trained model will be described later.

The method for acquiring the inference result by the inference performed by the inference unit 210 is not limited to the method for acquiring the inference result from the trained model by inputting the feature amount data D2 to the trained model. For example, the inference unit 210 may obtain an inference result by performing inference on the basis of the feature amount data D2 that is the input data using a predetermined inference rule. The inference rule is, for example, an if-then rule, an and-rule, or an or-rule.

The inference unit 210 uses the feature amount data D2 output from the feature amount extraction device 100 as input data. Therefore, the time-sequential inference apparatus 200 can perform inference with high accuracy since the feature amount data D2 output by the feature amount extraction device 100 is obtained by suppressing a noise component included in the time-sequential values of the time-sequential data.

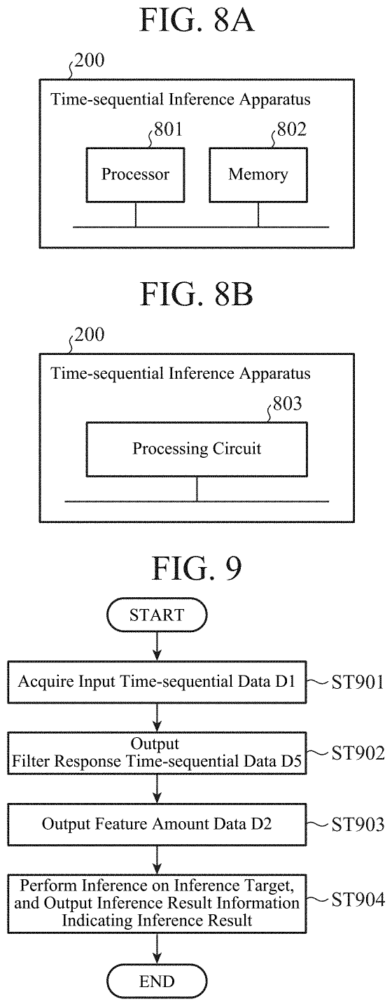

A hardware configuration of a main part of the time-sequential inference apparatus 200 according to the first embodiment will be described with reference to FIGS. 8A and 8B.

FIGS. 8A and 8B are diagrams illustrating an example of the hardware configuration of the main part of the time-sequential inference apparatus 200 according to the first embodiment.

As illustrated in FIG. 8A, the time-sequential inference apparatus 200 is implemented by a computer, and the computer includes a processor 801 and a memory 802.

The memory 802 stores a program for causing the computer to function as the inference unit 210, and the data acquisition unit 110, the multiple-filter application unit 120, and the feature amount extracting unit 130 included in the feature amount extraction device 100. The processor 801 reads and executes the program stored in the memory 802, thereby implementing the inference unit 210 and the data acquisition unit 110, the multiple-filter application unit 120, and the feature amount extracting unit 130 included in the feature amount extraction device 100.

In addition, as illustrated in FIG. 8B, the time-sequential inference apparatus 200 may include a processing circuit 803. In this case, the functions of the inference unit 210 and the data acquisition unit 110, the multiple-filter application unit 120, and the feature amount extracting unit 130 included in the feature amount extraction device 100 may be implemented by the processing circuit 803.

Furthermore, the time-sequential inference apparatus 200 may include the processor 801, the memory 802, and the processing circuit 803 (this configuration is not illustrated). In this case, some of the functions of the inference unit 210 and the data acquisition unit 110, the multiple-filter application unit 120, and the feature amount extracting unit 130 included in the feature amount extraction device 100 may be implemented by the processor 801 and the memory 802, and the remaining functions may be implemented by the processing circuit 803.

The processor 801, the memory 802, and the processing circuit 803 illustrated in FIG. 8A or 8B are similar to the processor 601, the memory 602, and the processing circuit 603 illustrated in FIG. 6A or 6B, and thus, the description thereof will be omitted.

The operation of the time-sequential inference apparatus 200 according to the first embodiment will be described with reference to FIG. 9.

FIG. 9 is a flowchart illustrating an example of processing performed by the time-sequential inference apparatus 200 according to the first embodiment.

First, in step ST901, the data acquisition unit 110 included in the feature amount extraction device 100 acquires the input time-sequential data D1.

Next, in step ST902, the multiple-filter application unit 120 included in the feature amount extraction device 100 applies a plurality of digital filters to the input time-sequential data D1, and outputs filter response time-sequential data D5 for each of the digital filters.

Next, in step ST903, the feature amount extracting unit 130 included in the feature amount extraction device 100 extracts a feature amount for each piece of filter response time-sequential data D5 and outputs feature amount data D2.

Next, in step ST904, the inference unit 210 performs inference on a predetermined inference target using the feature amount data D2 output from the feature amount extraction device 100 as input data, and outputs inference result information indicating an inference result.

After step ST904, the time-sequential inference apparatus 200 ends the processing of the flowchart. After completing the processing of the flowchart, the time-sequential inference apparatus 200 returns to step ST901 and repeatedly executes the processing of the flowchart.

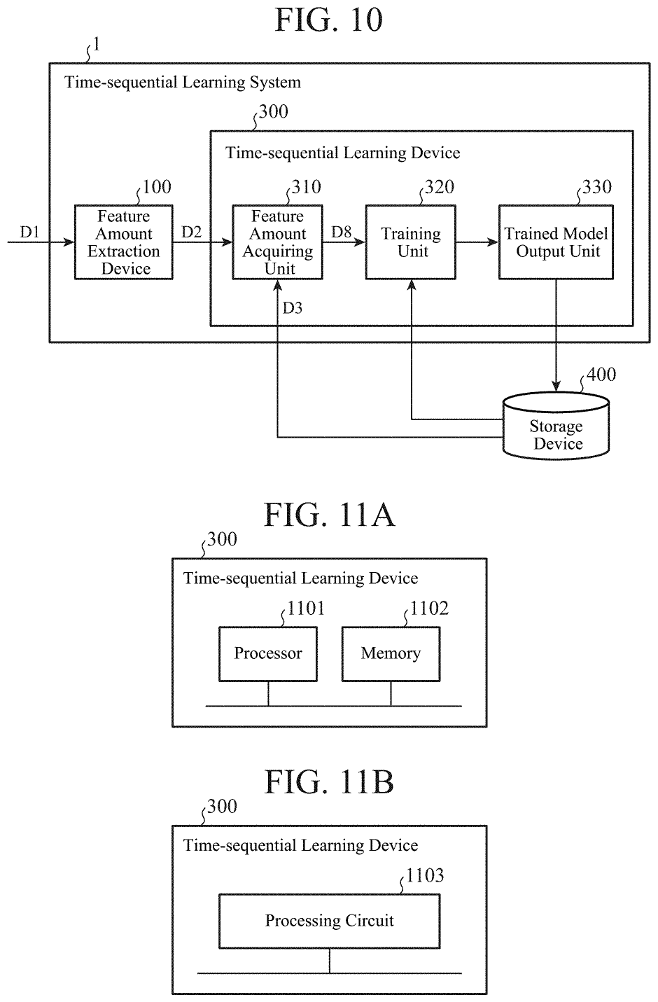

A time-sequential learning system 1 to which the feature amount extraction device 100 according to the first embodiment is applied will be described with reference to FIGS. 10 to 13.

FIG. 10 is a block diagram illustrating an example of the configuration of a main part of the time-sequential learning system 1 according to the first embodiment.

The time-sequential learning system 1 includes the feature amount extraction device 100, a time-sequential learning device 300, and a storage device 400.

The feature amount extraction device 100 included in the time-sequential learning system 1 is similar to the feature amount extraction device 100 included in the time-sequential inference apparatus 200, and thus the description thereof will be omitted.

The time-sequential learning device 300 acquires the feature amount data D2 output by the feature amount extraction device 100, generates a trained model using the acquired feature amount data D2, and outputs the generated trained model to the storage device 400.

The storage device 400 stores the trained model output by the time-sequential learning device 300.

The time-sequential inference apparatus 200 described above acquires the trained model by, for example, reading the trained model stored in the storage device 400.

The time-sequential learning device 300 includes a feature amount acquiring unit 310, a training unit 320, and a trained model output unit 330.

The feature amount acquiring unit 310 acquires the feature amount data D2 output from the feature amount extraction device 100.

Specifically, the feature amount acquiring unit 310 acquires a plurality of pieces of feature amount data D2 output by the feature amount extracting unit 130 included in the feature amount extraction device 100.

For example, the feature amount acquiring unit 310 acquires the feature amount data D2 output from the feature amount extraction device 100 via an information communication network such as a LAN or the Internet.

The feature amount acquiring unit 310 may acquire the feature amount data D2 output from the feature amount extraction device 100 via the storage device 400. Specifically, for example, the feature amount extraction device 100 outputs the feature amount data D2 to the storage device 400 and writes the output feature amount data D2 to the storage device 400, thereby storing the feature amount data D2 in the storage device 400 in advance. The feature amount acquiring unit 310 acquires the feature amount data D2 by reading the feature amount data D2 stored in advance in the storage device 400 from the storage device 400.

In addition, the time-sequential learning device 300 may include the feature amount extraction device 100 in the time-sequential learning device 300, and the feature amount acquiring unit 310 may directly acquire the feature amount data D2 output by the feature amount extraction device 100 included in the time-sequential learning device 300 from the feature amount extraction device 100.

FIG. 10 illustrates, as an example, a case where the feature amount extraction device 100 and the time-sequential learning device 300 are connected via an information communication network (not illustrated), and the feature amount acquiring unit 310 acquires the feature amount data D2 output by the feature amount extraction device 100 via the information communication network.

The training unit 320 trains the learning model using the feature amount data D2 acquired by the feature amount acquiring unit 310 as training data D8.

The training unit 320 trains the learning model and generates, as a trained model, the learning model that outputs an inference result obtained by inference for a predetermined inference target as inference result information.

Specifically, for example, the training unit 320 trains the learning model a predetermined number of times, ends the training after repeatedly training the learning model the predetermined number of times, and generates the trained model by using the learning model that has been trained as the trained model. The training unit 320 may generate the trained model in such a way that a user gives an instruction to stop the training by operating an operation input device (not illustrated), and the training unit 320 ends the training by acquiring operation information indicating the operation for instructing stop of the training, and sets the learning model that has been trained as the trained model.

Since the inference target has been described above, the description thereof will be omitted.

Note that the initial learning model is stored in the storage device 400 in advance, for example, and the training unit 320 acquires the initial learning model stored in advance in the storage device 400 by reading the initial learning model from the storage device 400. The training unit 320 repeatedly trains the acquired initial learning model to generate a trained model.

For example, the training unit 320 trains the learning model by supervised learning using, as the training data D8, the feature amount data D2 acquired by the feature amount acquiring unit 310 and teaching data D3 corresponding to the feature amount data D2.

FIG. 10 illustrates, as an example, the time-sequential learning device 300 in which the training unit 320 trains the learning model by supervised learning.

Specifically, for example, the teaching data D3 is stored in the storage device 400 in advance. The feature amount acquiring unit 310 acquires the teaching data D3 by reading the teaching data D3 stored in advance in the storage device 400 from the storage device 400. The training unit 320 trains the learning model by supervised learning using the feature amount data D2 acquired by the feature amount acquiring unit 310 and the teaching data D3 as training data D8.

The user may designate the teaching data D3 by operating the operation input device (not illustrated), and the feature amount acquiring unit 310 may acquire operation information indicating an operation of designating the teaching data D3 from the operation input device, and read the teaching data D3 designated by the operation indicated by the operation information from the storage device 400.

In addition, the user may input the teaching data D3 by operating the operation input device (not illustrated), and the feature amount acquiring unit 310 may acquire the teaching data D3 by acquiring operation information indicating the input teaching data D3 from the operation input device.

The training unit 320 trains the learning model by supervised learning using a known supervised learning algorithm such as linear regression, logistic regression, support vector machine, decision tree, random forest, gradient boosting tree, neural network, naive Bayes, AR, MA, or ARIMA model, state-space model, clustering, or ensemble learning.

The trained model output unit 330 outputs the trained model generated by the training unit 320. Specifically, for example, the trained model output unit 330 outputs the trained model generated by the training unit 320 to the storage device 400, and writes the output trained model in the storage device 400, whereby the trained model is stored in the storage device 400.

With the above configuration, the time-sequential learning device 300 can generate the trained model that enables the time-sequential inference apparatus 200 to perform inference with high accuracy.

A hardware configuration of a main part of the time-sequential learning device 300 according to the first embodiment will be described with reference to FIGS. 11A and 11B.

FIGS. 11A and 11B are diagrams illustrating an example of the hardware configuration of the main part of the time-sequential learning device 300 according to the first embodiment.

As illustrated in FIG. 11A, the time-sequential learning device 300 is implemented by a computer, and the computer includes a processor 1101 and a memory 1102.

The memory 1102 stores a program for causing the computer to function as the feature amount acquiring unit 310, the training unit 320, and the trained model output unit 330. The processor 1101 reads and executes the program stored in the memory 1102, thereby implementing the feature amount acquiring unit 310, the training unit 320, and the trained model output unit 330.

In addition, as illustrated in FIG. 11B, the time-sequential learning device 300 may include a processing circuit 1103. In this case, the functions of the feature amount acquiring unit 310, the training unit 320, and the trained model output unit 330 may be implemented by the processing circuit 1103.

Furthermore, the time-sequential learning device 300 may include the processor 1101, the memory 1102, and the processing circuit 1103 (this configuration is not illustrated). In this case, some of the functions of the feature amount acquiring unit 310, the training unit 320, and the trained model output unit 330 may be implemented by the processor 1101 and the memory 1102, and the remaining functions may be implemented by the processing circuit 1103.

The processor 1101, the memory 1102, and the processing circuit 1103 illustrated in FIG. 11A or 11B are similar to the processor 601, the memory 602, and the processing circuit 603 illustrated in FIG. 6A or 6B, and thus, the description thereof will be omitted.

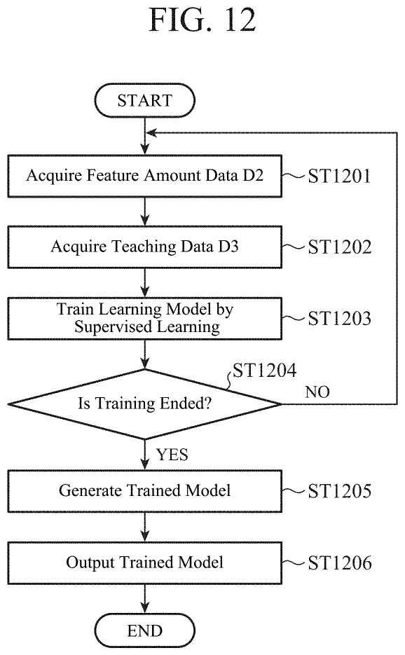

The operation of the time-sequential learning device 300 according to the first embodiment will be described with reference to FIG. 12.

FIG. 12 is a flowchart illustrating an example of processing performed by the time-sequential learning device 300 according to the first embodiment.

First, in step ST1201, the feature amount acquiring unit 310 acquires the feature amount data D2 output from the feature amount extraction device 100.

Next, in step ST1202, the feature amount acquiring unit 310 acquires the teaching data D3 corresponding to the feature amount data D2.

Next, in step ST1203, the training unit 320 trains the learning model by supervised learning using the feature amount data D2 and the teaching data D3 as training data D8.

Next, in step ST1204, the training unit 320 determines whether or not the training is ended.

When the training unit 320 determines in step ST1204 that the training is not ended, the time-sequential learning device 300 returns to the process of step ST1201 and repeatedly executes the processes from step ST1201 to step ST1204 until the training unit 320 determines that the training is ended.

When the training unit 320 determines in step ST1204 that the training is ended, the training unit 320 generates a trained model in step ST1205.

After step ST1205, the trained model output unit 330 outputs the trained model in step ST1206.

After step ST1206, the time-sequential learning device 300 ends the processing of the flowchart.

The time-sequential learning device 300 may include the training unit 320 that trains the learning model by unsupervised learning using the feature amount data D2 acquired by the feature amount acquiring unit 310 as the training data D8.

The training unit 320 trains the learning model by unsupervised learning using a known unsupervised learning algorithm such as clustering, principal component analysis, a self-organizing map, vector quantization, or a neural network.

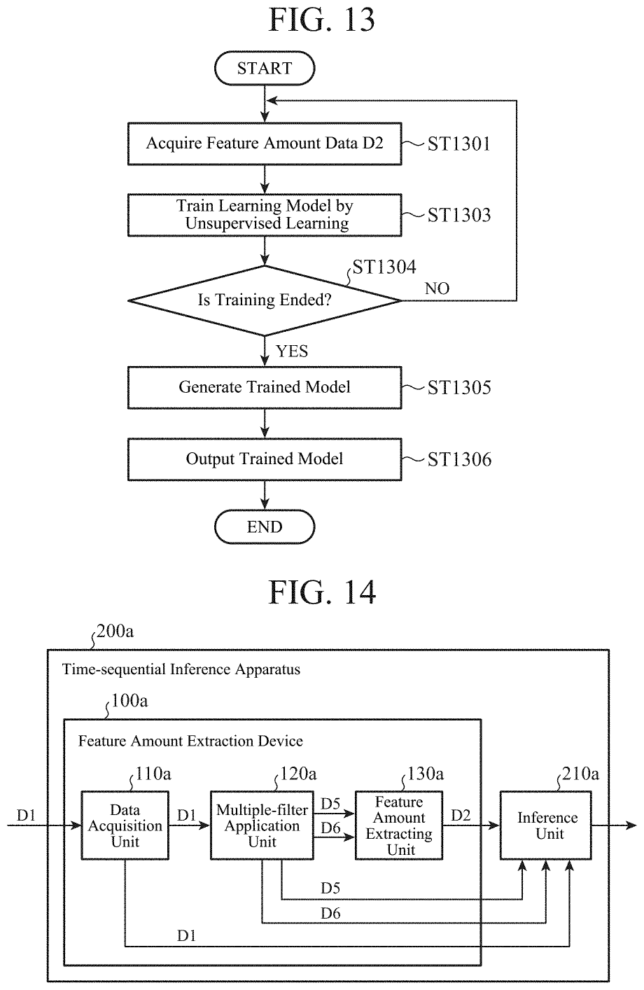

The operation of the time-sequential learning device 300 according to the first embodiment in a case where the time-sequential learning device 300 trains the learning model by unsupervised learning will be described with reference to FIG. 13.

FIG. 13 is a flowchart for describing an example of the processing performed by the time-sequential learning device 300 according to the first embodiment in a case where the time-sequential learning device 300 trains the learning model by unsupervised learning.

First, in step ST1301, the feature amount acquiring unit 310 acquires the feature amount data D2 output from the feature amount extraction device 100.

Next, in step ST1303, the training unit 320 trains the learning model by unsupervised learning using the feature amount data D2 as the training data D8.

Next, in step ST1304, the training unit 320 determines whether or not the training is ended.

When the training unit 320 determines in step ST1304 that the training is not ended, the time-sequential learning device 300 returns to the process of step ST1301 and repeatedly executes the processes from step ST1301 to step ST1304 until the training unit 320 determines that the training is ended.

When the training unit 320 determines in step ST1304 that the training is ended, the training unit 320 generates a trained model in step ST1305.

After step ST1305, the trained model output unit 330 outputs the trained model in step ST1306.

After step ST1306, the time-sequential learning device 300 ends the processing of the flowchart.

As described above, the feature amount extraction device 100 includes: the data acquisition unit 110 to acquire time-sequential data as the input time-sequential data D1; the multiple-filter application unit 120, including multiple digital filters, to apply each of the digital filters to the input time-sequential data D1 acquired by the data acquisition unit 110, and output, for each of the digital filters, filter response time-sequential data D5 that is time-sequential data including a time-sequential feature or a frequency feature after having undergone the application; and the feature amount extracting unit 130 to extract feature amounts for a plurality of pieces of the filter response time-sequential data D5 output from the multiple-filter application unit 120 for each of the plurality of pieces of the filter response time-sequential data D5, and output the feature amounts that have been extracted as feature amount data D2.

With this configuration, the feature amount extraction device 100 can suppress a noise component included in time-sequential values of the time-sequential data.

Specifically, the feature amount extraction device 100 includes the feature amount extracting unit 130, thereby being capable of outputting the feature amount data D2 in which the noise component included in the time-sequential values of the time-sequential data is suppressed even when the multiple-filter application unit 120 includes, for example, RPFB.

In addition, in the feature amount extraction device 100 having the above configuration, the feature amount extracting unit 130 applies a sliding window to each of the plurality of pieces of the filter response time-sequential data D5 output by the multiple-filter application unit 120 to extract statistics corresponding to each of the plurality of pieces of the filter response time-sequential data D5 as the feature amounts.

With this configuration, the feature amount extraction device 100 can suppress a noise component included in time-sequential values of the time-sequential data.

Specifically, the feature amount extraction device 100 includes the feature amount extracting unit 130, thereby being capable of outputting the feature amount data D2 in which the noise component included in the time-sequential values of the time-sequential data is suppressed even when the multiple-filter application unit 120 includes, for example, RPFB.

In addition, in the feature amount extraction device 100 having the above configuration, the feature amount extracting unit 130 applies the sliding window to the filter response time-sequential data D5 and performs envelope processing to extract the feature amount corresponding to the filter response time-sequential data D5.

With this configuration, the feature amount extraction device 100 can suppress a noise component included in the time-sequential values of the time-sequential data by performing envelope processing on the input time-sequential data.

Specifically, the feature amount extraction device 100 includes the feature amount extracting unit 130, thereby being capable of outputting the feature amount data D2 in which the noise component included in the time-sequential values of the time-sequential data is suppressed even when the multiple-filter application unit 120 includes, for example, RPFB.

In addition, in the feature amount extraction device 100 having the above configuration, the feature amount extracting unit 130 extracts the feature amount corresponding to the filter response time-sequential data D5 by performing envelope processing for extracting a maximum value of time-sequential values of the filter response time-sequential data D5 in a window.

With this configuration, the feature amount extraction device 100 can suppress a noise component included in the time-sequential values of the time-sequential data by performing envelope processing on the input time-sequential data.

Specifically, the feature amount extraction device 100 includes the feature amount extracting unit 130, thereby being capable of outputting the feature amount data D2 in which the noise component included in the time-sequential values of the time-sequential data is suppressed even when the multiple-filter application unit 120 includes, for example, RPFB.

In addition, in the feature amount extraction device 100 having the above configuration, the feature amount extracting unit 130 extracts the feature amount corresponding to the filter response time-sequential data D5 by performing envelope processing for extracting a minimum value of time-sequential values of the filter response time-sequential data D5 in a window.

With this configuration, the feature amount extraction device 100 can suppress a noise component included in the time-sequential values of the time-sequential data by performing envelope processing on the input time-sequential data.

Specifically, the feature amount extraction device 100 includes the feature amount extracting unit 130, thereby being capable of outputting the feature amount data D2 in which the noise component included in the time-sequential values of the time-sequential data is suppressed even when the multiple-filter application unit 120 includes, for example, RPFB.

In addition, in the feature amount extraction device 100 having the above configuration, the feature amount extracting unit 130 extracts the feature amount corresponding to the filter response time-sequential data D5 by performing envelope processing for extracting a mean value of time-sequential values of the filter response time-sequential data D5 in a window.

With this configuration, the feature amount extraction device 100 can suppress a noise component included in the time-sequential values of the time-sequential data by performing envelope processing on the input time-sequential data.

Specifically, the feature amount extraction device 100 includes the feature amount extracting unit 130, thereby being capable of outputting the feature amount data D2 in which the noise component included in the time-sequential values of the time-sequential data is suppressed even when the multiple-filter application unit 120 includes, for example, RPFB.

In addition, in the feature amount extraction device 100 having the above configuration, the feature amount extracting unit 130 extracts the feature amount corresponding to the filter response time-sequential data D5 by performing envelope processing for extracting a median value of time-sequential values of the filter response time-sequential data D5 in a window.

With this configuration, the feature amount extraction device 100 can suppress a noise component included in the time-sequential values of the time-sequential data by performing envelope processing on the input time-sequential data.

Specifically, the feature amount extraction device 100 includes the feature amount extracting unit 130, thereby being capable of outputting the feature amount data D2 in which the noise component included in the time-sequential values of the time-sequential data is suppressed even when the multiple-filter application unit 120 includes, for example, RPFB.

In addition, in the feature amount extraction device 100 having the above configuration, the feature amount extracting unit 130 extracts the feature amount corresponding to the filter response time-sequential data D5 by performing envelope processing for extracting a quartile of time-sequential values of the filter response time-sequential data D5 in a window.

With this configuration, the feature amount extraction device 100 can suppress a noise component included in the time-sequential values of the time-sequential data by performing envelope processing on the input time-sequential data.

Specifically, the feature amount extraction device 100 includes the feature amount extracting unit 130, thereby being capable of outputting the feature amount data D2 in which the noise component included in the time-sequential values of the time-sequential data is suppressed even when the multiple-filter application unit 120 includes, for example, RPFB.

In addition, as described above, the time-sequential inference apparatus 200 includes: the feature amount extraction device 100; and the inference unit 210 to perform inference on a predetermined inference target using the feature amount data D2 output from the feature amount extraction device 100 as input data, and output inference result information indicating an inference result.

With this configuration, the time-sequential inference apparatus 200 can perform inference with high accuracy since the feature amount data D2 output by the feature amount extraction device 100 is obtained by suppressing a noise component included in the time-sequential values of the time-sequential data.

In addition, in the time-sequential inference apparatus 200 having the above configuration, the inference unit 210 inputs the feature amount data D2 to a trained model corresponding to a learning result by machine learning, acquires the inference result information output as the inference result by the trained model, and outputs the acquired inference result information.

With this configuration, the time-sequential inference apparatus 200 can perform inference with high accuracy since the feature amount data D2 output by the feature amount extraction device 100 is obtained by suppressing a noise component included in the time-sequential values of the time-sequential data.

In addition, as described above, the time-sequential learning system 1 includes: the feature amount extraction device 100; and the time-sequential learning device 300, wherein the time-sequential learning device 300 includes the feature amount acquiring unit 310 to acquire the feature amount data D2 output by the feature amount extraction device 100, the training unit 320 to generate, as a trained model, the learning model that outputs an inference result obtained by inference for a predetermined inference target as inference result information by training the learning model using the feature amount data D2 acquired by the feature amount acquiring unit 310 as the training data D8, and the trained model output unit 330 to output the trained model generated by the training unit 320.

With the above configuration, the time-sequential learning system 1 can generate the trained model that enables the time-sequential inference apparatus 200 to perform inference with high accuracy.

### Second Embodiment

A feature amount extraction device 100a according to a second embodiment and a time-sequential inference apparatus 200a to which the feature amount extraction device 100a is applied will be described with reference to FIGS. 14 to 17.

FIG. 14 is a block diagram illustrating an example of configurations of main parts of the feature amount extraction device 100a and the time-sequential inference apparatus 200a according to the second embodiment.

The time-sequential inference apparatus 200a according to the second embodiment includes the feature amount extraction device 100a and an inference unit 210a. The time-sequential inference apparatus 200a will be described later.

The feature amount extraction device 100a according to the second embodiment includes a data acquisition unit 110a, a multiple-filter application unit 120a, and a feature amount extracting unit 130a.

The time-sequential inference apparatus 200a according to the second embodiment is different from the time-sequential inference apparatus 200 according to the first embodiment in that the feature amount extraction device 100 and the inference unit 210 are changed to the feature amount extraction device 100a and the inference unit 210a.

In addition, the feature amount extraction device 100a according to the second embodiment is different from the feature amount extraction device 100 according to the first embodiment in that the data acquisition unit 110, the multiple-filter application unit 120, and the feature amount extracting unit 130 are changed to the data acquisition unit 110a, the multiple-filter application unit 120a, and the feature amount extracting unit 130a.

The data acquisition unit 110a will be described.

The data acquisition unit 110a acquires time-sequential data as input time-sequential data D1.

The data acquisition unit 110 according to the first embodiment outputs the acquired input time-sequential data D1 only to the multiple-filter application unit 120.

On the other hand, the data acquisition unit 110a outputs the acquired input time-sequential data D1 to the multiple-filter application unit 120a and the inference unit 210a included in the time-sequential inference apparatus 200a.

The data acquisition unit 110a is similar to the data acquisition unit 110 according to the first embodiment except that the acquired input time-sequential data D1 is output to the multiple-filter application unit 120a and the inference unit 210a included in the time-sequential inference apparatus 200a, and thus, the detailed description of the data acquisition unit 110a will be omitted.

Note that the data acquisition unit 110a may not output the acquired input time-sequential data D1 to the inference unit 210a included in the time-sequential inference apparatus 200a. That is, the feature amount extraction device 100a according to the second embodiment may include the data acquisition unit 110 according to the first embodiment instead of the data acquisition unit 110a.

The multiple-filter application unit 120a will be described.

The multiple-filter application unit 120 according to the first embodiment includes a plurality of digital filters, applies each of the digital filters to the input time-sequential data D1 acquired by the data acquisition unit 110, and outputs, for each of the digital filters, filter response time-sequential data D5 that is time-sequential data having undergone the application.

On the other hand, the multiple-filter application unit 120a generates time-sequential data obtained by calculating differences or products between the input time-sequential data D1 and some or all pieces of the filter response time-sequential data D5 among the plurality of pieces of the filter response time-sequential data D5 output by the multiple-filter application unit 120a, and outputs the generated time-sequential data as filter response time-sequential data D6.

The multiple-filter application unit 120a outputs the filter response time-sequential data D6 to the feature amount extracting unit 130a. The multiple-filter application unit 120a may output the filter response time-sequential data D6 to the inference unit 210a included in the time-sequential inference apparatus 200a as well as to the feature amount extracting unit 130a.

In addition, the multiple-filter application unit 120a may also output the filter response time-sequential data D5 in addition to the filter response time-sequential data D6. In a case where the multiple-filter application unit 120a outputs the filter response time-sequential data D5 in addition to the filter response time-sequential data D6, the multiple-filter application unit 120a outputs the filter response time-sequential data D5 to the feature amount extracting unit 130a. The multiple-filter application unit 120a may output the filter response time-sequential data D5 to the inference unit 210a included in the time-sequential inference apparatus 200a as well as to the feature amount extracting unit 130a.

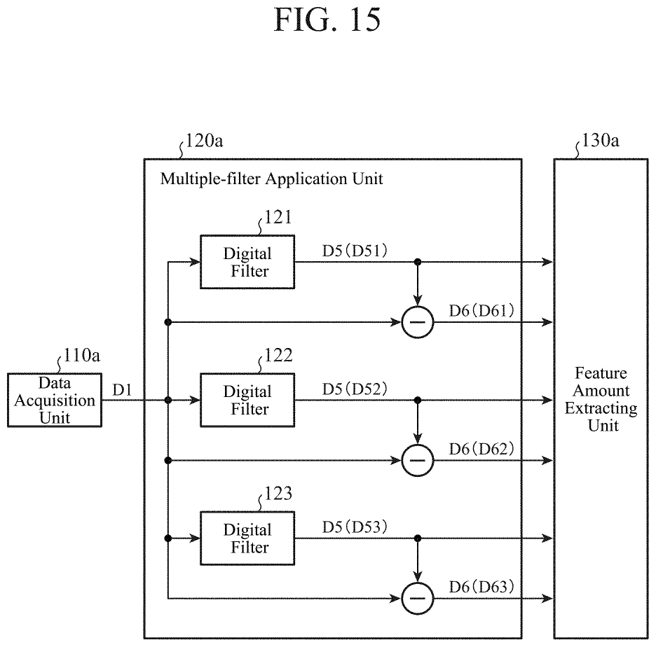

The multiple-filter application unit 120a according to the second embodiment will be described with reference to FIG. 15.

FIG. 15 is an explanatory diagram illustrating an example of the multiple-filter application unit 120a according to the second embodiment.

The multiple-filter application unit 120a includes a plurality of digital filters 121, 122, and 123.

FIG. 15 illustrates, as an example, the multiple-filter application unit 120a including three digital filters 121, 122, and 123. The number of digital filters included in the multiple-filter application unit 120a is not limited to three, and may be two or four or more as long as it is two or more.

The multiple-filter application unit 120a applies each of the digital filters 121, 122, and 123 to the input time-sequential data D1 acquired by the data acquisition unit 110a. Each of the plurality of digital filters 121, 122, and 123 included in the multiple-filter application unit 120a performs filtering processing on the input time-sequential data D1, and the digital filters 121, 122, and 123 output filter response time-sequential data D51, D52, and D53 which are time-sequential data having undergone the filtering processing.

The multiple-filter application unit 120a divides each of the plurality of pieces of filter response time-sequential data D51, D52, and D53 output by the multiple-filter application unit 120a into two, a first piece and a second piece.

The multiple-filter application unit 120a outputs, to the feature amount extracting unit 130a, filter response time-sequential data D51, D52, and D53 which are first pieces of the plurality of pieces of filter response time-sequential data D51, D52, and D53 divided into two.

In addition, the multiple-filter application unit 120a outputs, to the feature amount extracting unit 130a, filter response time-sequential data D61, D62, and D63 which are time-sequential data obtained by calculating differences or products between the input time-sequential data D1 and the second pieces of the plurality of pieces of the filter response time-sequential data D51, D52, and D53 divided into two.

FIG. 15 illustrates a case where the multiple-filter application unit 120a outputs the filter response time-sequential data D51, D52, and D53 to the feature amount extracting unit 130a in addition to the filter response time-sequential data D61, D62, and D63.

In addition, FIG. 15 illustrates a case where all of the plurality of pieces of filter response time-sequential data D51, D52, and D53 output by the multiple-filter application unit 120a are divided into two, and filter response time-sequential data D61, D62, and D63 obtained by calculating differences between the input time-sequential data D1 and the second pieces of all of the filter response time-sequential data D51, D52, and D53 divided into two are output to the feature amount extracting unit 130a and the inference unit 210a included in the time-sequential inference apparatus 200a.

The multiple-filter application unit 120a may divide only some of the plurality of pieces of filter response time-sequential data D51, D52, and D53 output by the multiple-filter application unit 120a into two.

In addition, the multiple-filter application unit 120a may calculate differences between the input time-sequential data D1 and the second pieces of some of the divided filter response time-sequential data D51, D52, and D53, and may calculate products between the input time-sequential data D1 and the second pieces of the remaining data.

In addition, the multiple-filter application unit 120a may divide each of the plurality of pieces of filter response time-sequential data D51, D52, and D53 output by the multiple-filter application unit 120a into three, and output, to the feature amount extracting unit 130a, filter response time-sequential data D61, D62, and D63 obtained by calculating differences between the input time-sequential data D1 and the respective pieces of the filter response time-sequential data D51, D52, and D53 and filter response time-sequential data D61, D62, and D63 obtained by calculating products between the input time-sequential data D1 and the respective pieces of the filter response time-sequential data D51, D52, and D53.

The feature amount extracting unit 130a will be described.

The feature amount extracting unit 130 according to the first embodiment extracts feature amounts for the plurality of pieces of the filter response time-sequential data D5 output by the multiple-filter application unit 120 for each of the plurality of pieces of the filter response time-sequential data D5, and outputs the extracted feature amounts as feature amount data D2.

On the other hand, the feature amount extracting unit 130a extracts feature amounts for the plurality of pieces of the filter response time-sequential data D6 output by the multiple-filter application unit 120a for each of the plurality of pieces of the filter response time-sequential data D6, and outputs the extracted feature amounts as feature amount data D2.

The method for extracting feature amounts for the filter response time-sequential data D6 by the feature amount extracting unit 130a is similar to the method for extracting feature amounts for the filter response time-sequential data D5 by the feature amount extracting unit 130 according to the first embodiment, and thus, the description thereof will be omitted.

With this configuration, the feature amount extraction device 100a can suppress a noise component included in the time-sequential values of the time-sequential data.

Specifically, the feature amount extraction device 100a includes the feature amount extracting unit 130a, thereby being capable of outputting the feature amount data D2 in which the noise component included in the time-sequential values of the time-sequential data is suppressed even when the multiple-filter application unit 120a includes, for example, RPFB.

In a case where the multiple-filter application unit 120a outputs the filter response time-sequential data D5 in addition to the filter response time-sequential data D6, the feature amount extracting unit 130a also extracts feature amounts for the plurality of pieces of the filter response time-sequential data D5 for each of the plurality of pieces of the filter response time-sequential data D5, in addition to the feature amounts for the plurality of pieces of the filter response time-sequential data D6 output by the multiple-filter application unit 120a, and outputs the extracted feature amounts as feature amount data D2.

Note that the functions of the data acquisition unit 110a, the multiple-filter application unit 120a, and the feature amount extracting unit 130a included in the feature amount extraction device 100a may be implemented by the processor 601 and the memory 602 in the hardware configuration illustrated as an example in FIGS. 6A and 6B, or may be implemented by the processing circuit 603.

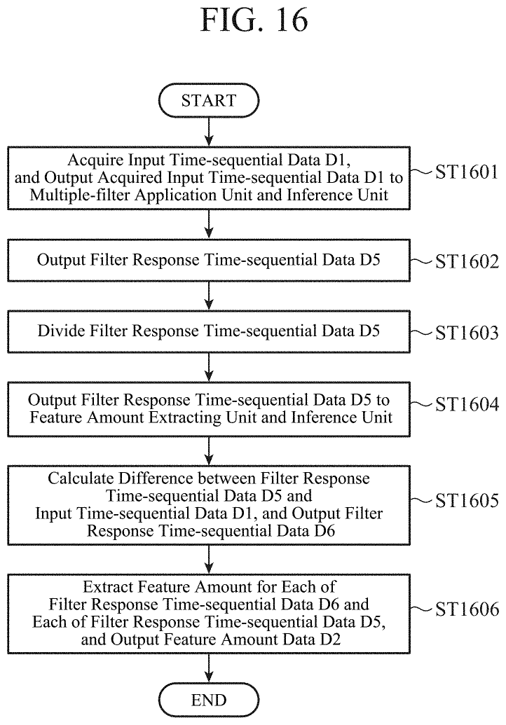

The operation of the feature amount extraction device 100a according to the second embodiment will be described with reference to FIG. 16.

FIG. 16 is a flowchart illustrating an example of processing performed by the feature amount extraction device 100a according to the second embodiment.

First, in step ST1601, the data acquisition unit 110a acquires the input time-sequential data D1, and outputs the acquired input time-sequential data D1 to the multiple-filter application unit 120a and the inference unit 210a included in the time-sequential inference apparatus 200a.

Next, in step ST1602, the multiple-filter application unit 120a applies a plurality of digital filters to the input time-sequential data D1, and outputs filter response time-sequential data D5 for each of the digital filters.

Next, in step ST1603, the multiple-filter application unit 120a divides each of the plurality of pieces of filter response time-sequential data D5 output by the multiple-filter application unit 120a into two, a first piece and a second piece.

Next, in step ST1604, the multiple-filter application unit 120a outputs the first piece of the filter response time-sequential data D5 divided into two by the multiple-filter application unit 120a to the feature amount extracting unit 130a and the inference unit 210a included in the time-sequential inference apparatus 200a.

Next, in step ST1605, the multiple-filter application unit 120a calculates a difference between the input time-sequential data D1 and the second piece of the filter response time-sequential data D5 divided into two by the multiple-filter application unit 120a, and outputs filter response time-sequential data D6 which is time-sequential data obtained by calculating the difference to the feature amount extracting unit 130a and the inference unit 210a included in the time-sequential inference apparatus 200a.

Next, in step ST1606, the feature amount extracting unit 130a extracts feature amounts for each piece of the filter response time-sequential data D6 and each piece of the filter response time-sequential data D5, and outputs feature amount data D2.

After step ST1606, the feature amount extraction device 100a ends the processing of the flowchart. After completing the processing of the flowchart, the feature amount extraction device 100a returns to step ST1601 and repeatedly executes the processing of the flowchart.

As described above, the time-sequential inference apparatus 200a according to the second embodiment includes the feature amount extraction device 100a and the inference unit 210a.

The inference unit 210a performs inference on a predetermined inference target using the feature amount data D2 output from the feature amount extraction device 100a as input data, and outputs inference result information indicating an inference result.

Specifically, the inference unit 210a performs inference on a predetermined inference target using a plurality of pieces of feature amount data D2 output from the feature amount extracting unit 130a included in the feature amount extraction device 100a as input data.

For example, similar to the inference unit 210 according to the first embodiment, the inference unit 210a may output the inference result information using a trained model, or may perform inference using a predetermined inference rule and output the inference result information indicating the inference result.

In a case where the data acquisition unit 110a included in the feature amount extraction device 100a outputs the input time-sequential data D1 to the inference unit 210a, the inference unit 210a may perform inference on a predetermined inference target also using the input time-sequential data D1 in addition to the plurality of pieces of feature amount data D2 as input data.

Due to the inference unit 210a performing inference also using the input time-sequential data D1 in addition to the feature amount data D2 as the input data as described above, the time-sequential inference apparatus 200a can perform inference with higher accuracy as compared with a case where the inference unit 210a performs inference using only the feature amount data D2 as the input data.

In addition, in a case where the multiple-filter application unit 120a included in the feature amount extraction device 100a outputs the filter response time-sequential data D6 to the inference unit 210a, the inference unit 210a may perform inference on a predetermined inference target also using the filter response time-sequential data D6 in addition to the plurality of pieces of feature amount data D2 as input data.

Due to the inference unit 210a performing inference also using the filter response time-sequential data D6 in addition to the feature amount data D2 as the input data as described above, the time-sequential inference apparatus 200a can perform inference with higher accuracy as compared with a case where the inference unit 210a performs inference using only the feature amount data D2 as the input data.

In addition, in a case where the multiple-filter application unit 120a included in the feature amount extraction device 100a outputs the filter response time-sequential data D5 to the inference unit 210a, the inference unit 210a may perform inference on a predetermined inference target also using the filter response time-sequential data D5 in addition to the plurality of pieces of feature amount data D2 as input data.

Due to the inference unit 210a performing inference also using the filter response time-sequential data D5 in addition to the feature amount data D2 as the input data as described above, the time-sequential inference apparatus 200a can perform inference with higher accuracy as compared with a case where the inference unit 210a performs inference using only the feature amount data D2 as the input data.

Note that the functions of the inference unit 210a included in the time-sequential inference apparatus 200a, and the data acquisition unit 110a, the multiple-filter application unit 120a, and the feature amount extracting unit 130a included in the feature amount extraction device 100a included in the time-sequential inference apparatus 200a may be implemented by the processor 801 and the memory 802 in the hardware configuration illustrated as an example in FIGS. 8A and 8B, or may be implemented by the processing circuit 803.

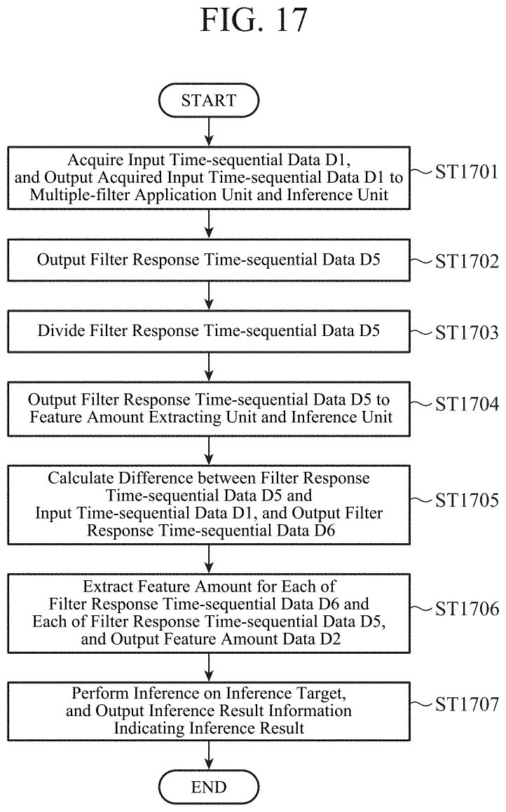

The operation of the time-sequential inference apparatus 200a according to the second embodiment will be described with reference to FIG. 17.

FIG. 17 is a flowchart illustrating an example of processing performed by the time-sequential inference apparatus 200a according to the second embodiment.

First, in step ST1701, the data acquisition unit 110a included in the feature amount extraction device 100a acquires the input time-sequential data D1, and outputs the acquired input time-sequential data D1 to the multiple-filter application unit 120a included in the feature amount extraction device 100a and the inference unit 210a.

Next, in step ST1702, the multiple-filter application unit 120a included in the feature amount extraction device 100a applies a plurality of digital filters to the input time-sequential data D1, and outputs filter response time-sequential data D5 for each of the digital filters.

Next, in step ST1703, the multiple-filter application unit 120a included in the feature amount extraction device 100a divides each of the plurality of pieces of filter response time-sequential data D5 output by the multiple-filter application unit 120a included in the feature amount extraction device 100a into two, a first piece and a second piece.

Next, in step ST1704, the multiple-filter application unit 120a included in the feature amount extraction device 100a outputs the first piece of the filter response time-sequential data D5 divided into two by the multiple-filter application unit 120a included in the feature amount extraction device 100a to the feature amount extracting unit 130a included in the feature amount extraction device 100a and the inference unit 210a.

Next, in step ST1705, the multiple-filter application unit 120a included in the feature amount extraction device 100a calculates a difference between the input time-sequential data D1 and the second piece of the filter response time-sequential data D5 divided into two by the multiple-filter application unit 120a included in the feature amount extraction device 100a, and outputs filter response time-sequential data D6 which is time-sequential data obtained by calculating the difference to the feature amount extracting unit 130a included in the feature amount extraction device 100a and the inference unit 210a.

Next, in step ST1706, the feature amount extracting unit 130a included in the feature amount extraction device 100a extracts feature amounts for each piece of the filter response time-sequential data D6 and each piece of the filter response time-sequential data D5, and outputs feature amount data D2.

Next, in step ST1707, the inference unit 210a performs inference on an inference target using, as input data, the feature amount data D2, the input time-sequential data D1, the filter response time-sequential data D5, and the filter response time-sequential data D6 output from the feature amount extraction device 100a, and outputs inference result information indicating an inference result.

After step ST1707, the time-sequential inference apparatus 200a ends the processing of the flowchart. After completing the processing of the flowchart, the time-sequential inference apparatus 200a returns to step ST1701 and repeatedly executes the processing of the flowchart.

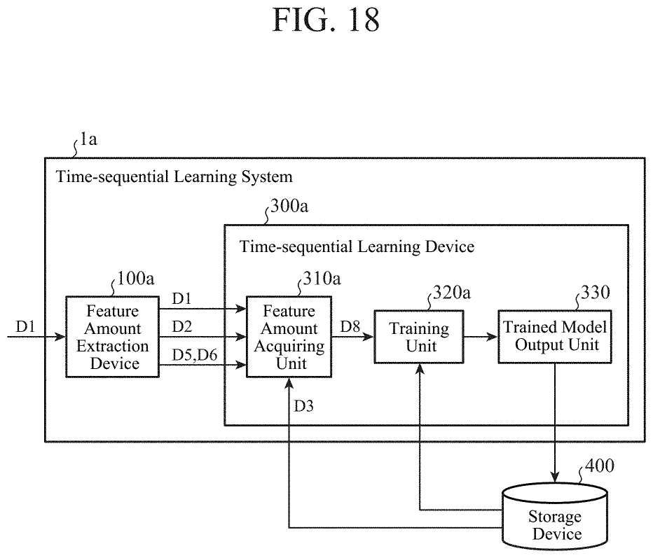

A time-sequential learning system 1a to which the feature amount extraction device 100a according to the second embodiment is applied will be described with reference to FIG. 18.

FIG. 18 is a block diagram illustrating an example of the configuration of the main part of the time-sequential learning system 1a according to the second embodiment.

The time-sequential learning system 1a includes the feature amount extraction device 100a, a time-sequential learning device 300a, and a storage device 400.

The feature amount extraction device 100a included in the time-sequential learning system 1a is similar to the feature amount extraction device 100a included in the time-sequential inference apparatus 200a, and thus the description thereof will be omitted. In addition, the storage device 400 according to the second embodiment is similar to the storage device 400 according to the first embodiment, and thus, the description thereof will be omitted.

The time-sequential learning device 300a acquires the feature amount data D2 output by the feature amount extraction device 100a, generates a trained model using the acquired feature amount data D2, and outputs the generated trained model to the storage device 400.

The storage device 400 stores the trained model output by the time-sequential learning device 300a.

The time-sequential inference apparatus 200a described above acquires the trained model by, for example, reading the trained model stored in the storage device 400.

The time-sequential learning device 300a includes a feature amount acquiring unit 310a, a training unit 320a, and a trained model output unit 330.

The feature amount acquiring unit 310a acquires the feature amount data D2 output from the feature amount extraction device 100a.

The feature amount acquiring unit 310a may acquire, in addition to the feature amount data D2, the input time-sequential data D1, the filter response time-sequential data D5, or the filter response time-sequential data D6 output by the feature amount extraction device 100a.

The training unit 320a trains the learning model using the feature amount data D2 acquired by the feature amount acquiring unit 310a as training data D8.

Specifically, the training unit 320a trains the learning model by supervised learning or unsupervised learning using the feature amount data D2 as the training data D8.

FIG. 18 illustrates the time-sequential learning device 300a in which the training unit 320a trains the learning model by supervised learning.

The training unit 320a generates, as a trained model, a learning model that outputs an inference result obtained by inference for a predetermined inference target as inference result information by training the learning model.

Specifically, the method for training the learning model by the training unit 320a and the method for generating the trained model by the training unit 320a are similar to the method for training the learning model by the training unit 320 and the method for generating the trained model by the training unit 320 according to the first embodiment, and thus, the description thereof will be omitted.

In a case where the feature amount acquiring unit 310a acquires the input time-sequential data D1, the filter response time-sequential data D5, or the filter response time-sequential data D6 output by the feature amount extraction device 100a in addition to the feature amount data D2, the training unit 320a trains the learning model using, as the training data D8, the input time-sequential data D1, the filter response time-sequential data D5, or the filter response time-sequential data D6 in addition to the feature amount data D2.

Due to the training unit 320a training the learning model using, as the training data D8, the input time-sequential data D1, the filter response time-sequential data D5, or the filter response time-sequential data D6 in addition to the feature amount data D2 as described above, the time-sequential learning device 300a can generate a trained model that enables the time-sequential inference apparatus 200 to perform inference with higher accuracy as compared with a case where the training unit 320a trains the learning model using only the feature amount data D2 as the training data D8.

The trained model output unit 330 outputs the trained model generated by the training unit 320a.

Note that the functions of the feature amount acquiring unit 310a, the training unit 320a, and the trained model output unit 330 included in the time-sequential learning device 300a may be implemented by the processor 1101 and the memory 1102 in the hardware configuration illustrated as an example in FIGS. 11A and 11B, or may be implemented by the processing circuit 1103.

The operation of the time-sequential learning device 300a, that is, the processing performed by the time-sequential learning device 300a, is substantially similar to the processing performed by the time-sequential learning device 300 according to the first embodiment, and thus, the description thereof will be omitted.

As described above, the feature amount extraction device 100a includes: the data acquisition unit 110a to acquire time-sequential data as the input time-sequential data D1; the multiple-filter application unit 120a, including a plurality of digital filters, to apply each of the digital filters to the input time-sequential data D1 acquired by the data acquisition unit 110a, and output, for each of the digital filters, filter response time-sequential data D5 which is time-sequential data including a time-sequential feature or a frequency feature and having undergone the application; and the feature amount extracting unit 130a to extract feature amounts for a plurality of pieces of the filter response time-sequential data D5 output by the multiple-filter application unit 120a for each of the plurality of pieces of the filter response time-sequential data D5, and output the extracted feature amounts as feature amount data D2, wherein the multiple-filter application unit 120a generates time-sequential data obtained by calculating differences or products between the input time-sequential data D1 acquired by the data acquisition unit 110a and some or all of the plurality of pieces of the filter response time-sequential data D5 output by the multiple-filter application unit 120a, and outputs the generated time-sequential data as the filter response time-sequential data D6.

With this configuration, the feature amount extraction device 100a can suppress a noise component included in the time-sequential values of the time-sequential data.

Specifically, the feature amount extraction device 100a includes the feature amount extracting unit 130a, thereby being capable of outputting the feature amount data D2 in which the noise component included in the time-sequential values of the time-sequential data is suppressed even when the multiple-filter application unit 120a includes, for example, RPFB.

Therefore, the time-sequential inference apparatus 200a can perform inference with high accuracy since the feature amount data D2 output by the feature amount extraction device 100a is obtained by suppressing the noise component included in the time-sequential values of the time-sequential data.

In addition, the time-sequential learning device 300a can generate a trained model that enables the time-sequential inference apparatus 200a to perform inference with high accuracy since the feature amount data D2 output by the feature amount extraction device 100a is obtained by suppressing a noise component included in the time-sequential values of the time-sequential data.

It is to be noted that two or more of the above embodiments can be freely combined, or any component in the embodiments can be modified or omitted, within the scope of the present disclosure.

### INDUSTRIAL APPLICABILITY

The feature amount extraction device according to the present disclosure can be applied to an inference apparatus that performs inference on an inference target on the basis of time-sequential data, or a learning device or a learning system that generates a trained model which is used when the inference apparatus performs inference.

### REFERENCE SIGNS LIST

1, 1a: time-sequential learning system, 100, 100a: feature amount extraction device, 110, 110a: data acquisition unit, 120, 120a: multiple-filter application unit, 121, 122, 123: digital filter, 130, 130a: feature amount extracting unit, 200, 200a: time-sequential inference apparatus, 210, 210a: inference unit, 300, 300a: time-sequential learning device, 310, 310a: feature amount acquiring unit, 320, 320a: training unit, 330: trained model output unit, 400: storage device, 601, 801, 1101: processor, 602, 802, 1102: memory, 603, 803, 1103: processing circuit, D1: input time-sequential data, D2, D21, D22: feature amount data, D3: teaching data, D5, D51, D52, D53, D6, D61, D62, D63: filter response time-sequential data, D8: training data

1. A feature amount extraction device comprising:
a data acquirer to acquire time-sequential data as input time-sequential data;
a multiple-filter applicator, including multiple digital filters randomly selected, to apply each of the digital filters to the input time-sequential data acquired by the data acquirer and output, for each of a plurality of the digital filters, filter response time-sequential data that is time-sequential data including a time-sequential feature or a frequency feature after having undergone the application; and
a feature amount extractor to extract feature amounts for a plurality of pieces of the filter response time-sequential data output from the multiple-filter applicator for each of the plurality of pieces of the filter response time-sequential data, and output a plurality of the feature amounts that have been extracted as feature amount data.

2. The feature amount extraction device according to claim 1,
wherein the multiple-filter applicator generates time-sequential data obtained by calculating differences or products between the input time-sequential data acquired by the data acquirer and some or all of the plurality of pieces of the filter response time-sequential data output by the multiple-filter applicator, and outputs the generated time-sequential data as the filter response time-sequential data.

3. The feature amount extraction device according to claim 1,
wherein the feature amount extractor applies a sliding window to each of the plurality of pieces of the filter response time-sequential data output by the multiple-filter applicator to extract statistics corresponding to each of the plurality of pieces of the filter response time-sequential data as the feature amounts.

4. The feature amount extraction device according to claim 3,
wherein the feature amount extractor applies the sliding window to the filter response time-sequential data and performs envelope processing to extract the feature amount corresponding to the filter response time-sequential data.

5. The feature amount extraction device according to claim 4,
wherein the feature amount extractor extracts the feature amount corresponding to the filter response time-sequential data by performing envelope processing for extracting a maximum value of time-sequential values of the filter response time-sequential data in a window.

6. The feature amount extraction device according to claim 4,
wherein the feature amount extractor extracts the feature amount corresponding to the filter response time-sequential data by performing envelope processing for extracting a minimum value of time-sequential values of the filter response time-sequential data in a window.

7. The feature amount extraction device according to claim 4,
wherein the feature amount extractor extracts the feature amount corresponding to the filter response time-sequential data by performing envelope processing for extracting a mean value of time-sequential values of the filter response time-sequential data in a window.

8. The feature amount extraction device according to claim 4,
wherein the feature amount extractor extracts the feature amount corresponding to the filter response time-sequential data by performing envelope processing for extracting a median value of time-sequential values of the filter response time-sequential data in a window.

9. The feature amount extraction device according to claim 4,
wherein the feature amount extractor extracts the feature amount corresponding to the filter response time-sequential data by performing envelope processing for extracting a quartile of time-sequential values of the filter response time-sequential data in a window.

10. A time-sequential inference apparatus comprising:
the feature amount extraction device according to claim 1; and
an inferencer to perform inference on a predetermined inference target using the feature amount data output from the feature amount extraction device as input data, and output inference result information indicating an inference result.

11. The time-sequential inference apparatus according to claim 10,
wherein the inferencer inputs the feature amount data to a trained model corresponding to a learning result by machine learning, acquires the inference result information output as the inference result by the trained model, and outputs the acquired inference result information.

12. A time-sequential learning system comprising:
the feature amount extraction device according to claim 1; and
a time-sequential learning device,
wherein the time-sequential learning device includes
a feature amount acquirer to acquire the feature amount data output by the feature amount extraction device,
a trainer to generate, as a trained model, the learning model that outputs an inference result obtained by inference for a predetermined inference target as inference result information by training a learning model using the feature amount data acquired by the feature amount acquirer as training data, and
a trained model outputter to output the trained model generated by the training trainer.

13. A feature amount extraction method comprising:
to acquire time-sequential data as input time-sequential data;
to apply, using a plurality of digital filters randomly selected, each of the digital filters to the input time-sequential data acquired, and output, for each of a plurality of the digital filters, filter response time-sequential data that is time-sequential data including a time-sequential feature or a frequency feature after having undergone the application; and
to extract feature amounts for a plurality of pieces of the filter response time-sequential data output for each of the plurality of pieces of the filter response time-sequential data, and output a plurality of the feature amounts that have been extracted as feature amount data.

14. A time-sequential inference method comprising:
to output the feature amount data by a feature amount extraction device with the feature amount extraction method according to claim 13; and
to perform inference for a predetermined inference target using the feature amount data output as input data, and output inference result information indicating an inference result.

15. The time-sequential inference method according to claim 14,
wherein the method includes inputting the feature amount data to a trained model corresponding to a learning result by machine learning, acquiring the inference result information output as the inference result by the trained model, and outputting the acquired inference result information.

16. A time-sequential learning method comprising:
to output the feature amount data by a feature amount extraction device with the feature amount extraction method according to claim 13;
to acquire the feature amount data output;
to train a learning model using the feature amount data acquired as training data, and generate, as a trained model, the learning model that outputs an inference result obtained by inference for a predetermined inference target as inference result information; and
to output the trained model generated.
